(19) United States
(12) Patent Application Publication
(10) Pub. No.: US 2016/0359241 A1
(43) Pub. Date: Dec. 8, 2016

(54) CONNECTING TERMINAL

(71) Applicant: DONGGUAN JIASHENG LIGHTING TECHNOLOGY CO. LTD., Dogguan City (CN)

(72) Inventor: Shuisheng Xu, Dongguan City (CN)

(21) Appl. No.: 15/042,470

(22) Filed: Feb. 12, 2016

(30) Foreign Application Priority Data
Jun. 5, 2015 (CN) 201520390497.2

(51) Int. Cl. H01R 4/22

(52) U.S. Cl. CPC H01R 4/22

(57) ABSTRACT

A connecting terminal includes a hollow body with one end being open and the other end being closed, having an inner cavity adapted to fit a wire. The body is provided with a first pressure seal portion adjacent to the open end adapted to deform under clamping pressure, and an inner wall of the body is provided with a waterproof layer. The inner cavity of the body includes a first inner cavity and a second inner cavity in communication with each other. The first inner cavity is adjacent to the open end and fit a wire. The diameter of the second inner cavity is smaller than or equal to the diameter of the first inner cavity, and the first inner cavity corresponds to the first pressure seal portion. The connecting terminal of the present disclosure has the advantages of fast installation as well as waterproof.

### FIELD

The present disclosure relates to a connecting terminal.

### BACKGROUND

Connecting terminals are widely used in electronic products. A connecting terminal connects the lines of two systems (devices or electrical appliances) or splits a line to adjust the branch orientation of various lines. For example, when installing a plurality of LED lamps or tube lamps, it is required that a plurality of branch wires are derived from a bus wire every a certain distance one another, each branch wire is connected to a lamp via a connecting terminal, and all the branch wires are connected in parallel to the bus wire. Traditional connecting terminals are mainly used inside the relevant systems (equipments or appliances), do not have a waterproof performance or have a poor waterproof performance, and are easy to fall off.

### SUMMARY

In view of the above, the present disclosure is aimed to overcome the deficiencies of the prior art by providing a connecting terminal which is waterproof with fast installation.

A connecting terminal includes a hollow body with one end being open and the other end being closed, having an inner cavity adapted to fit a wire, wherein the body is provided with a first pressure seal portion adjacent to the open end adapted to deform under clamping pressure, and an inner wall of the body is provided with a waterproof layer.

In an embodiment, the inner cavity of the body may include a first inner cavity and a second inner cavity in communication with each other. The first inner cavity may be adjacent to the open end and fit a wire. The diameter of the second inner cavity may be smaller than or equal to the diameter of the first inner cavity, and the first inner cavity may be corresponding to the first pressure seal portion.

In an embodiment, the body may be further provided with a second pressure seal portion corresponding to the second inner cavity.

In an embodiment, the second pressure seal portion may be integral with the body.

In an embodiment, the waterproof layer may be a silica gel layer.

In an embodiment, the first pressure seal portion may be integral with the body.

Upon deformation of the first pressure seal portion under clamping pressure, the inner waterproof layer can tightly encapsulate the wire to prevent water and dust from entering inside. The connecting terminal of the present disclosure has the advantages of fast installation as well as waterproof.

### BRIEF DESCRIPTION OF THE DRAWINGS

FIG. 1 is a structural schematic diagram of a connecting terminal of the present disclosure.

FIG. 2 is a schematic diagram of application of a connecting terminal of the present disclosure.

FIG. 3 is a schematic diagram of the first and second pressure seal portions of FIG. 2 after being clamped.

FIG. 4 is a schematic diagram of application of a connecting terminal of the present disclosure.

### LIST OF REFERENCE SIGNS

1. connecting terminal 11. first inner cavity 12. second inner cavity 13. first pressure seal portion 14. second pressure seal portion 15. waterproof layer 2. wire 21. first wire 22. second wire 3. lamp

### DETAILED DESCRIPTION OF THE PREFERRED EMBODIMENTS

An embodiment of the present disclosure will be described in detail with reference to the accompanying drawings.

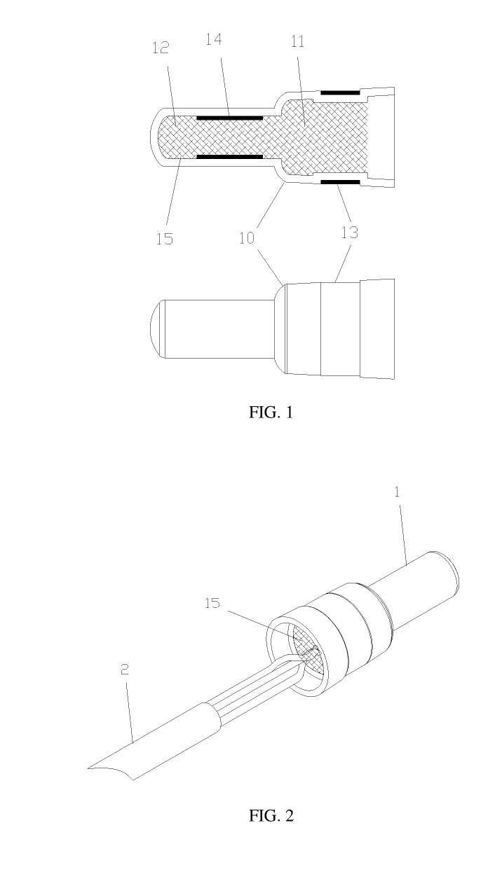

As shown in FIG. 1, a connecting terminal 1 includes a hollow body, one end of the body is an open end and the other end of the body is a closed end. An inner cavity of the body fits a wire 2. The body is provided with a first pressure seal portion 13 adjacent to the open end adapted to deform under clamping pressure. An inner wall of the body is provided with a waterproof layer 15. After inserting the wire 2 into the cavity of the body, apply clamping pressure onto the first pressure seal portion 13 with tools (for example, pliers) to fix the connecting terminal on the wire 2. Moreover, by deformation of the first pressure seal portion 13, the inside waterproof layer 15 can tightly encapsulate the wire 2 to prevent water and dust from entering inside. The connecting terminal 1 of the present disclosure has the advantages of fast installation as well as waterproof.

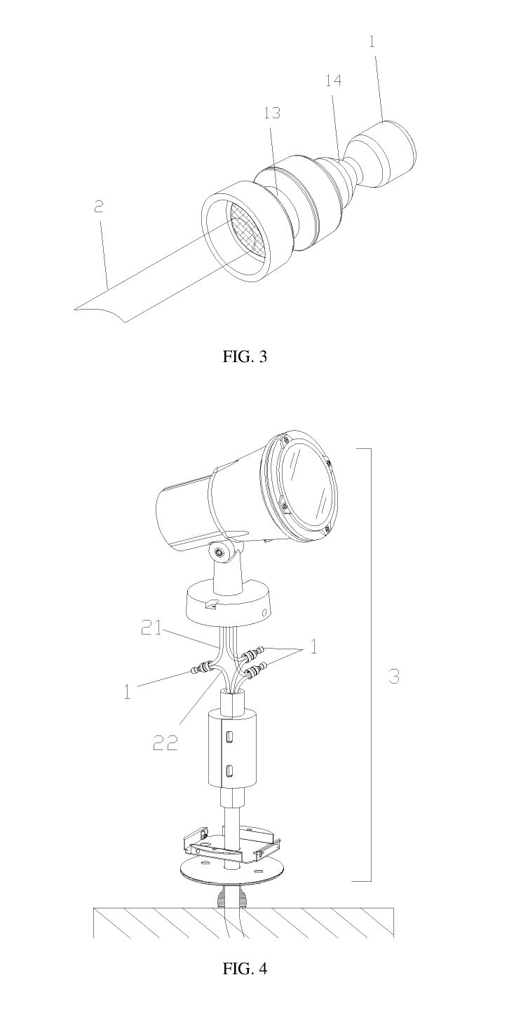

In the embodiment, the inner cavity of the body may include a first inner cavity 11 and a second inner cavity 12 in communication with each other. The first inner cavity 11 is adjacent to the open end and fits a wire 2. The diameter of the second inner cavity 12 may be smaller than or equal to the diameter of the first inner cavity 11. The first inner cavity 11 is corresponding to the first pressure seal portion 13. The first pressure seal portion 11 is integral with the body. The body is further provided with a second pressure seal portion 14 corresponding to the second inner cavity 12. The second pressure seal portion is also integral with the body. As shown in FIGS. 2 and 3, it is possible to enhance the fixation by the second pressure seal portion 14 to prevent falling of the connecting terminal 1. In addition, the waterproof layer is a silica gel layer, which possesses good elasticity and waterproof effect.

FIG. 4 illustrates the application of the connecting terminal 1 in installation of a lamp 3. After connecting a first wire 21 and a second wire 22 and inserting them into the connecting terminal 1, clamping pressure is applied onto the first pressure seal portion 13 and the second pressure seal portion 14 with tools (for example, pliers) to fix the connecting terminal 1 on a connecting portion of the first wire 21 and the second wire 22 and meanwhile realize waterproof. Even if water seepage from the wall flows into the lamp along the wire, it can hardly enter the inside of the connecting terminal 1 thanks to the protection means of the connecting terminal 1.

It is possible to combine arbitrarily the technical features mentioned above. For the sake of simplicity, descriptions of the other possible combinations of the various features are omitted. However, any combination of the features shall be deemed as within the scope of the present disclosure as long as the features are not contradictious with each other.

The described embodiments of the present disclosure are presented for the purpose of illustration, not limitation. It will be apparent to those skilled in the art that various modifications can be made to the above-described exemplary embodiments of the present utility model without departing from the spirit or scope of the invention. Thus, it is intended that the present invention covers all such modifications provided they come within the scope of the appended claims and their equivalents.

1. A connecting terminal, comprising:
a hollow body with one end being open and the other end being closed, having an inner cavity adapted to fit a wire,
wherein the body is provided with a first pressure seal portion adjacent to the open end adapted to deform under clamping pressure, and an inner wall of the body is provided with a waterproof layer.

2. The connecting terminal of claim 1, wherein the inner cavity of the body comprises a first inner cavity and a second inner cavity in communication with each other, the first inner cavity is adjacent to the open end and fits a wire, the diameter of the second inner cavity is smaller than or equal to the diameter of the first inner cavity, and the first inner cavity is corresponding to the first pressure seal portion.

3. The connecting terminal of claim 2, wherein the body is further provided with a second pressure seal portion corresponding to the second inner cavity.

4. The connecting terminal of claim 3, wherein the second pressure seal portion is integral with the body.

5. The connecting terminal of claim 1, wherein the waterproof layer is a silica gel layer.

6. The connecting terminal of claim 1, wherein the first pressure seal portion is integral with the body.
